(19) United States
(12) Patent Application Publication
(10) Pub. No.: US 2023/0287697 A1
(43) Pub. Date: Sep. 14, 2023

(54) Concrete Member Reinforcement Method and Concrete Reinforcement Structure

(71) Applicant: Fuzhou University, Fuzhou (CN)

(72) Inventors: Shaofei Jiang, Fuzhou (CN); Rongbin Zang, Fuzhou (CN); Hualin Song, Fuzhou (CN)

(21) Appl. No.: 18/109,434

(22) Filed: Feb. 14, 2023

(30) Foreign Application Priority Data
Mar. 9, 2022 (CN) 202210221592.4

(51) Int. Cl. E04G 23/02

(52) U.S. Cl. CPC E04G 23/0218; E04G 2023/0251

(57) ABSTRACT

Provided are a concrete member reinforcement method and a concrete reinforcement structure. The concrete reinforcement structure includes a concrete member, a first bonding body, a second bonding body, and a fiber-reinforced composite strip. At least one groove is formed on a surface of the concrete member, and a first binder is used for filling the groove to form a first bonding body. A second binder is used for being coated on the surface of the concrete member provided with the groove, as well as the top surface of the first bonding body to form a second bonding body. The fiber-reinforced composite strip is used for being pasted on a surface, far away from the first bonding body, of the second bonding body, so that the fiber-reinforced composites can be firmly combined with the concrete member and are not easy to fall off.

### CROSS-REFERENCE TO RELATED APPLICATION

This patent application claims the benefit and priority of Chinese Patent Application No. 202210221592.4, filed with the China National Intellectual Property Administration on Mar. 9, 2022, the disclosure of which is incorporated by reference herein in its entirety as part of the present application.

### TECHNICAL FIELD

The present disclosure relates to the technical field of concrete structure reinforcement, and in particular to a concrete member reinforcement method and a concrete reinforcement structure.

### BACKGROUND

With the passage of time, due to years of environmental erosion and the impact of natural disasters, a large number of in-service concrete members have been seriously damaged, changed in their structural functions, and can no longer meet the existing code requirements, thus the concrete members need to be repaired and strengthened to varying degrees.

To reinforce the existing concrete members and improve their structure performance to meet the existing code requirements, a large number of new materials and technologies have emerged. Among them, fiber-reinforced composites are increasingly favored by the concrete member reinforcement industry due to their light weight, high strength, good corrosion resistance, efficient and convenient construction and little influence on the structure appearance.

The existing concrete member reinforcement method is to roughen the surface of concrete member, coat primer, and then attach fiber-reinforced composite sheets to the surface of concrete member by using professionally equipped epoxy resin. However, most of the actual concrete members are in harsh environments, especially in coastal areas, where the concrete members are seriously damaged by corrosive media; moreover, the epoxy resin used for pasting the fiber-reinforced composites is highly susceptible to deterioration due to environmental influences, the bond strength is reduced, which causes debonding failure of the bond interface, resulting in low utilization rate of tensile properties of the fiber-reinforced composite sheets and poor reinforcement effect.

Therefore, to solve the problem that the existing bonding-reinforcement method is susceptible to debonding failure of the bond interface, there is an urgent need for a new concrete member reinforcement method and a concrete reinforcement structure.

### SUMMARY

An objective of the present disclosure is to provide a concrete member reinforcement method and a concrete reinforcement structure to solve the problems in the prior art, so that the fiber-reinforced composites can be firmly combined with the concrete member and are not easy to fall off.

To achieve the objective above, the present disclosure provides the following solutions:

The present disclosure provides a concrete member reinforcement method, including the following steps:

step one, forming at least one groove on a first surface of a concrete member;

step two, filling the groove with a first binder to form a first bonding body;

step three, coating a second binder on the first surface provided with the groove, as well as a top surface of the first bonding body to form a second bonding body;

step four, pasting a fiber-reinforced composite strip on a surface, away from the first bonding body, of the second bonding body.

Preferably, a ratio of the total area of an opening, on the surface of the concrete member, of the groove to the area of the surface of the concrete member provided with the groove is [0.01667, 0.15].

Preferably, the opening of the groove has a depth of [2.5, 7.5] mm.

Preferably, the opening of the groove gradually widens on the concrete member in a direction away from the first surface.

Preferably, the fiber-reinforced composite strip can completely cover the groove.

Preferably, the cross-sectional shape of the fiber-reinforced composite strip is rectangular.

Preferably, the fiber-reinforced composite strip is woven from long fiber filaments.

The present disclosure further provides a concrete reinforcement structure, including a concrete member, a first bonding body, a second bonding body, and a fiber-reinforced composite strip. At least one groove is formed on a first surface of the concrete member, a first binder is configured to fill the groove to form a first bonding body; a second binder is configured to be coated on the first surface, as well as a top surface of the first bonding body to form the second bonding body; and the fiber-reinforced composite strip is configured to be pasted on a surface, far away from the first bonding body, of the second bonding body.

Preferably, a ratio of the total area of an opening, on the first surface, of the groove to the area of the first surface is [0.01667, 0.15], the opening of the groove has a depth of [2.5, 7.5] mm, and the opening of the groove gradually widens on the concrete member in a direction away from the first surface.

Preferably, the fiber-reinforced composite strip can completely cover the groove; the cross-sectional shape of the fiber-reinforced composite strip is rectangular; and the fiber-reinforced composite strip is woven from long fiber filaments.

Compared with the prior art, the present disclosure has the following technical effects: In accordance with the concrete member reinforcement method provided by the embodiment, by filling the groove formed on the surface of the concrete member with the first binder and coating the second binder on the surface of the concrete member provided with the groove and the top surface of the first bonding body, the bond area between the fiber reinforcement composite strip and the concrete member can be increased, the bond strength is increased, and thus the strength utilization rate and the reinforcement effect of the fiber sheets are improved. Moreover, the concrete member can play a certain role in protecting the first bonding body. It is to be noted here that the first binder and the second binder should be the same or compatible with each other.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a concrete reinforcement structure in accordance with the present disclosure;

FIG. 2 is a schematic diagram of a cross section of a concrete reinforcement structure in FIG. 1;

FIG. 3 is a schematic diagram of a concrete member in a concrete reinforcement structure in accordance with the present disclosure;

In the drawings: 100—concrete reinforcement structure; 1—concrete member; 11—groove; 2—first bonding body; 3—second bonding body; 4—fiber-reinforced composite strip.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

An objective of the present disclosure is to provide a concrete member reinforcement method and a concrete reinforcement structure to solve the problems in the prior art, so that the fiber-reinforced composites can be firmly combined with the concrete member and are not easy to fall off.

To make the objectives, features and advantages of the present disclosure more apparently and understandably, the following further describes the present disclosure in detail with reference to the accompanying drawings and the specific embodiments.

### Embodiment 1

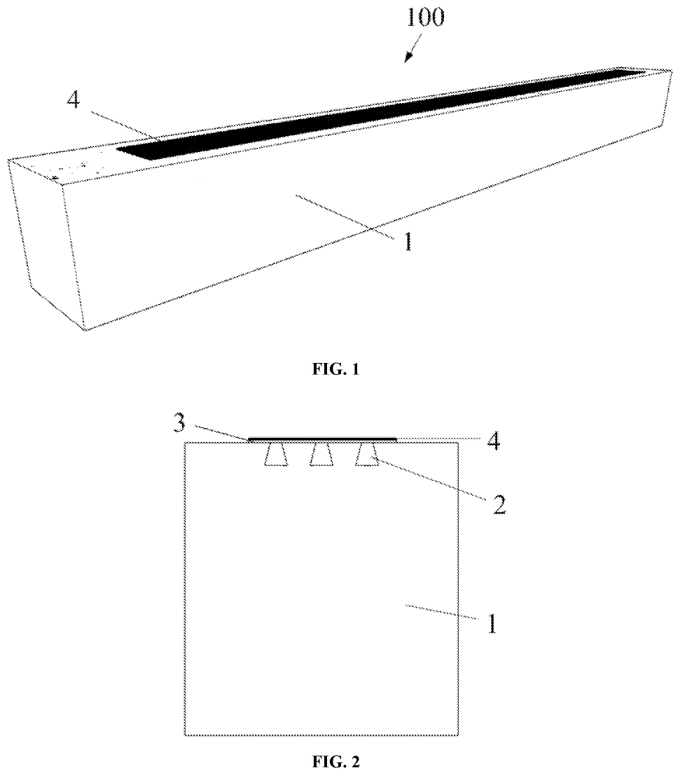

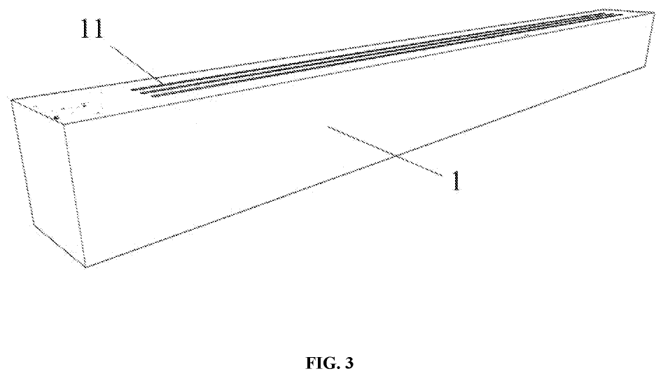

As shown in FIG. 1 to FIG. 3, the embodiment provides a concrete member reinforcement method, including the following steps:

step one, forming at least one groove 11 on a first surface of a concrete member 1;

step two, filling the groove 11 with a first binder to form a first bonding body 2;

step three, coating a second binder on the first surface provided with the groove, as well as a top surface of the first bonding body 2 to form a second bonding body 3;

step four, pasting a fiber-reinforced composite strip 4 on a surface, away from the first bonding body 2, of the second bonding body 3.

Therefore, in accordance with the concrete member reinforcement method provided by the embodiment, as shown in FIG. 1 to FIG. 3, by filling the groove 11 formed on the first surface of the concrete member 1 with the first binder and coating the second binder on the surface of the concrete member 1 provided with the groove 11 as well as the top surface of the first bonding body 2, the bond area between the fiber reinforcement composite strip 4 and the concrete member 1 can be increased, the bond strength is increased, and thus the strength utilization rate and the reinforcement effect of the fiber sheets are improved. Moreover, the concrete member 1 can play a certain role in protecting the first bonding body 2. It is to be noted that the first binder and the second binder should be the same or compatible with each other.

Further, as shown in FIG. 1 to FIG. 3, a ratio of the total area of an opening, on the first surface of the concrete member 1, of the groove 11 to the area of the first surface of the concrete member 1 provided with the groove 11 is [0.01667, 0.15]. In the embodiment, the opening, on the first surface of the concrete member 1, of the groove 11 has a length of 1,200 mm and a width of 5 mm; and the first surface of the concrete member 1 provided with the groove 11 has a length of 1,400 mm and a width of 120 mm.

Further, as shown in FIG. 1 to FIG. 3, the opening of the groove 11 has a depth of [2.5, 7.5] mm. In the embodiment, the opening of the groove 11 has a depth of 7.5 mm.

Further, as shown in FIG. 1 to FIG. 3, the opening of the groove 11 gradually widens on the concrete member 1 in a direction away from the first surface of the concrete member 1 provided with the groove 11. In the embodiment, the cross-sectional shape of the opening of the groove 11 is trapezoid, and the opening, on the first surface of the concrete member 1, of the groove 11 forms a trapezoid with an upper base of 5 mm and a lower base of 7.5 mm.

Further, as shown in FIG. 1 to FIG. 3, the fiber reinforcement composite strip 4 can completely cover the groove 11. In the embodiment, the fiber reinforcement composite strip 4 has a width of 80 mm and a length of 1,220 mm.

Further, as shown in FIG. 1 to FIG. 3, the cross-sectional shape of the fiber reinforcement composite strip 4 is rectangular. In the embodiment, the rectangular cross section of the fiber reinforcement composite strip 4 has a length of 80 mm and a width of 1 mm.

Further, as shown in FIG. 1 to FIG. 3, the fiber-reinforced composite strip 4 is woven from long fiber filaments, which has good toughness and can improve the reinforcement effect of the concrete member 1.

### Embodiment 2

It is provided a concrete reinforcement structure 100 according to an embodiment. As shown in FIG. 1 to FIG. 3, the concrete reinforcement structure 100 includes a concrete member 1, a first bonding body 2, a second bonding body 3, and a fiber-reinforced composite strip 4. At least one groove 11 is formed on a first surface of the concrete member 1, a first binder is configured to fill the groove 11 to form a first bonding body 2. A second binder is configured to be coated on the first surface of the concrete member 1 provided with the groove 11, as well as a top surface of the first bonding body 2 to form the second bonding body 3. The fiber-reinforced composite strip 4 is configured to be pasted on a surface, far away from the first bonding body 2, of the second bonding body 3.

In accordance with the concrete member 1 reinforcement structure provided by the embodiment, by filling the groove 11 formed on the first surface of the concrete member 1 with the first binder and coating the second binder on the surface of the concrete member 1 provided with the groove 11 as well as the top surface of the first bonding body 2, the bond area between the fiber reinforcement composite strip 4 and the concrete member 1 can be increased, the bond strength is increased, and thus the strength utilization rate and the reinforcement effect of the fiber sheets are improved. Moreover, the concrete member 1 can play a certain role in protecting the first bonding body 2. It is to be noted that the first binder and the second binder should be the same or compatible with each other.

Further, as shown in FIG. 1 to FIG. 3, a ratio of the total area of an opening, on the first surface of the concrete member 1, of the groove 11 to the area of the first surface of the concrete member 1 provided with the groove 11 is [0.01667, 0.15]. The opening of the groove 11 has a depth of [2.5, 7.5] mm. The opening of the groove 11 gradually widens on the concrete member 1 in a direction away from the first surface of the concrete member 1 provided with the groove 11. In the embodiment, the opening, on the first surface of the concrete member 1, of the groove 11 has a length of 1,200 mm and a width of 5 mm. The first surface of the concrete member 1 provided with the groove 11 has a length of 1,400 mm and a width of 120 mm. The opening of the groove 11 has a depth of 7.5 mm, and the cross-sectional shape of the opening of the groove 11 is trapezoid. The opening, on the first surface of the concrete member 1, of the groove 11 forms a trapezoid with an upper base of 5 mm and a bottom base of 7.5 mm.

Further, as shown in FIG. 1 to FIG. 3, the fiber reinforcement composite strip 4 can completely cover the groove 11. The cross-sectional shape of the fiber reinforcement composite strip 4 is rectangular. The fiber-reinforced composite strip 4 is woven from long fiber filaments, which has good toughness and can improve the reinforcement effect of the concrete member 1. In the embodiment, the fiber reinforcement composite strip 4 has a width of 80 mm, a length of 1,220 m, and a thickness of 1 mm.

Several examples are used for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A concrete member reinforcement method, comprising the following steps:
step one, forming at least one groove on a first surface of a concrete member;
step two, filling the groove with a first binder to form a first bonding body;
step three, coating a second binder on the first surface provided with the groove, as well as a top surface of the first bonding body to form a second bonding body;
step four, pasting a fiber-reinforced composite strip on a surface, away from the first bonding body, of the second bonding body.

2. The concrete member reinforcement method according to claim 1, wherein a ratio of the total area of an opening, on the first surface, of the groove to the area of the first surface is [0.01667, 0.15].

3. The concrete member reinforcement method according to claim 1, wherein the opening of the groove has a depth of [2.5, 7.5] mm.

4. The concrete member reinforcement method according to claim 1, wherein the opening of the groove gradually widens on the concrete member in a direction away from the first surface.

5. The concrete member reinforcement method according to claim 1, wherein the fiber-reinforced composite strip is able to completely cover the groove.

6. The concrete member reinforcement method according to claim 1, wherein the cross-sectional shape of the fiber-reinforced composite strip is rectangular.

7. The concrete member reinforcement method according to claim 1, wherein the fiber-reinforced composite strip is woven from long fiber filaments.

8. A concrete reinforcement structure, comprising a concrete member, a first bonding body, a second bonding body, and a fiber-reinforced composite strip, wherein at least one groove is formed on a first surface of the concrete member, a first binder is used for filling the groove to form a first bonding body, a second binder is configured to be coated on the first surface, as well as a top surface of the first bonding body to form the second bonding body, and the fiber-reinforced composite strip is configured to be pasted on a surface, far away from the first bonding body, of the second bonding body.

9. The concrete reinforcement structure according to claim 8, wherein a ratio of the total area of an opening, on the first surface, of the groove to the area of the first surface is [0.01667, 0.15], the opening of the groove has a depth of [2.5, 7.5] mm, and the opening of the groove gradually widens on the concrete member in a direction away from the first surface.

10. The concrete member reinforcement method according to claim 8, wherein the fiber-reinforced composite strip is able to completely cover the groove; the cross-sectional shape of the fiber-reinforced composite strip is rectangular; and the fiber-reinforced composite strip is woven from long fiber filaments.
